(19) United States
(12) Patent Application Publication
(10) Pub. No.: US 2024/0119787 A1
(43) Pub. Date: Apr. 11, 2024

(54) TABLE GAME SYSTEM INCLUDING A GAMING TABLE DISPLAY ASSEMBLY AND METHOD FOR OPERATING GAMING TABLE DISPLAY ASSEMBLIES

(71) Applicant: Galaxy Gaming, Inc., Las Vegas, NV (US)

(72) Inventor: Steve Cvetkoski, Henderson, NV (US)

(21) Appl. No.: 18/378,441

(22) Filed: Oct. 10, 2023

Related U.S. Application Data
(60) Provisional application No. 63/414,844, filed on Oct. 10, 2022.

(51) Int. Cl. G07F 17/32

(52) U.S. Cl. CPC G07F 17/322; G07F 17/3244

(57) ABSTRACT

A gaming table display assembly associated with a physical gaming table is described herein. The gaming table display assembly includes a display unit for displaying computer-generated images and a gaming controller operably coupled to the display unit. The gaming controller includes a processor programmed to execute an algorithm to render an animated sequence of computer-generated images on the display unit including the steps of rendering a game screen on the display unit including an animated progressive jackpot award image and an animated progressive award paytable image and rendering the animated progressive award paytable image including a plurality of fixed-pay hand bonus award images. Each fixed-pay hand bonus award image includes a card hand image indicating a corresponding playing card hand and a modifiable bonus award image.

### CROSS-REFERENCE TO RELATED APPLICATION

This application claims the benefit of U.S. Provisional Patent Application Ser. No. 63/414,844, filed Oct. 10, 2022, the disclosures of which are hereby incorporated by reference in its entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

At least some known casino card tables include electronic trend boards and dealer terminals that allow the dealer to input game outcomes into the dealer terminal to display a game history on the electronic trend boards. At least some known electronic trend boards may display game paytables associated with the current card game being played at the associated gaming table. However, there is a need in the casino industry to provide a greater variety of visual animations on known electronic trend boards to attract and maintain player engagement at the card tables. The present invention solves one or more of the problems identified above.

### SUMMARY OF THE INVENTION

In one aspect of the present invention, a table game system is provided. The table game system includes a physical gaming table, a card reader device, and a gaming table display assembly coupled to the physical gaming table. The card reader device is configured to acquire information from a physical playing card being dealt onto the physical gaming table. The gaming table display assembly includes a display unit for displaying computer-generated images and a gaming controller operably coupled to the display unit and the card reader device. The gaming controller includes a processor programmed to execute an algorithm to render an animated sequence of computer-generated images on the display unit including the steps of rendering a game screen on the display unit including an animated progressive jackpot award image and an animated progressive award paytable image and rendering the animated progressive award paytable image including a plurality of fixed-pay hand bonus award images. Each fixed-pay hand bonus award image includes a card hand image indicating a corresponding playing card hand and a modifiable bonus award image. The processor receives a signal from the card reader device indicating card values associated with physical playing cards dealt to a player and a dealer, and initiates an instance of a bonus progressive card game by: randomly selecting a fixed-pay hand bonus award image being displayed on the animated progressive award paytable image, randomly selecting an award boost value for the randomly selected fixed-pay hand bonus award image, animating the modifiable bonus award image associated with the randomly selected fixed-pay hand bonus award image to transform from an initial baseline award value to the selected boosted award value, determining a player bonus hand based on the card values associated with two playing cards dealt to the player and one playing card dealt to the dealer, and animating an award image onto the game screen upon determining the player bonus hand matches one of the fixed-pay hand bonus award images.

In another aspect of the present invention, a gaming table display assembly associated with a physical gaming table is provided. The gaming table display assembly includes a display unit for displaying computer-generated images and a gaming controller operably coupled to the display unit. The gaming controller includes a processor programmed to execute an algorithm to render an animated sequence of computer-generated images on the display unit including the steps of rendering a game screen on the display unit including an animated progressive jackpot award image and an animated progressive award paytable image and rendering the animated progressive award paytable image including a plurality of fixed-pay hand bonus award images. Each fixed-pay hand bonus award image includes a card hand image indicating a corresponding playing card hand and a modifiable bonus award image. The processor receives a signal from a card reader device indicating card values associated with physical playing cards dealt to a player and a dealer and initiates an instance of a bonus progressive card game by randomly selecting a fixed-pay hand bonus award image being displayed on the animated progressive award paytable image, randomly selecting an award boost value for the randomly selected fixed-pay hand bonus award image, animating the modifiable bonus award image associated with the randomly selected fixed-pay hand bonus award image to transform from an initial baseline award value to the selected boosted award value, determining a player bonus hand based on the card values associated with two playing cards dealt to the player and one playing card dealt to the dealer, and animating an award image onto the game screen upon determining the player bonus hand matches one of the fixed-pay hand bonus award images.

In yet another aspect of the present invention, a method of operating a gaming table display assembly associated with a physical gaming table is provided. The gaming table display assembly includes a display unit for displaying computer-generated images and a gaming controller including a processor operably coupled to the display unit. The method includes the processor performing an algorithm to render an animated sequence of computer-generated images on the display unit including the steps of rendering a game screen on the display unit including an animated progressive jackpot award image and an animated progressive award paytable image and rendering the animated progressive award paytable image including a plurality of fixed-pay hand bonus award images. Each fixed-pay hand bonus award image including a card hand image indicating a corresponding playing card hand and a modifiable bonus award image. The processor receives a signal from a card reader device indicating card values associated with physical playing cards dealt to a player and a dealer and initiates an instance of a bonus progressive card game by: randomly selecting a fixed-pay hand bonus award image being displayed on the animated progressive award paytable image, randomly selecting an award boost value for the randomly selected fixed-pay hand bonus award image, animating the modifiable bonus award image associated with the randomly selected fixed-pay hand bonus award image to transform from an initial baseline award value to the selected boosted award value, determining a player bonus hand based on the card values associated with two playing cards dealt to the player and one playing card dealt to the dealer; and animating an award image onto the game screen upon determining the player bonus hand matches one of the fixed-pay hand bonus award images.

### BRIEF DESCRIPTION OF DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1-4 are a schematic view of a table game system, according to an embodiment of the present invention;

FIG. 5 is a schematic view of a networked computer system including the table game system shown in FIG. 1, according to an embodiment of the present invention;

FIG. 6 is a flow chart illustrating an algorithm executed by the system to display an animated sequence of computer-generated images, according to one embodiment of the present invention;

FIG. 7 is an illustration of a data file that may be used to execute the algorithm shown in FIG. 6; and

FIGS. 8-11 are exemplary illustrations of animated sequences of computer-generated images of game screens illustrating the algorithms shown in FIG. 6.

Corresponding reference characters indicate corresponding parts throughout the drawings.

### DETAILED DESCRIPTION OF EMBODIMENTS

With reference to the drawings and in operation, the present invention is directed towards a table game system that includes an electronic trend board that displays variable a variable paytable. By modifying the paytable images being displayed on the electronic trend board, the present invention improves electronic trend board technology by providing an electronic trend board with a processor and random number generator for use in modifying the images rendered on the trend board display to increase player engagement. In the illustrated embodiment, the processor of the electronic trend board is programed to execute a progressive model where prior to each deal, a random number of “fixed pay” hands (e.g., 1 to 3 hands out of the possible 4) have their pays adjusted to a higher value than their default value (e.g., from $5 to $12).

To provide players the kind of dynamic pay variation that they are more apt to see while playing slot machines. For the most part, table games have been based on fixed pays or progressive jackpot meters with percentage-based pays. The Dynamic Progressive changes the fixed pay concept where each deal yields a higher pay, as compared to the default values, on one or more of the fixed pays.

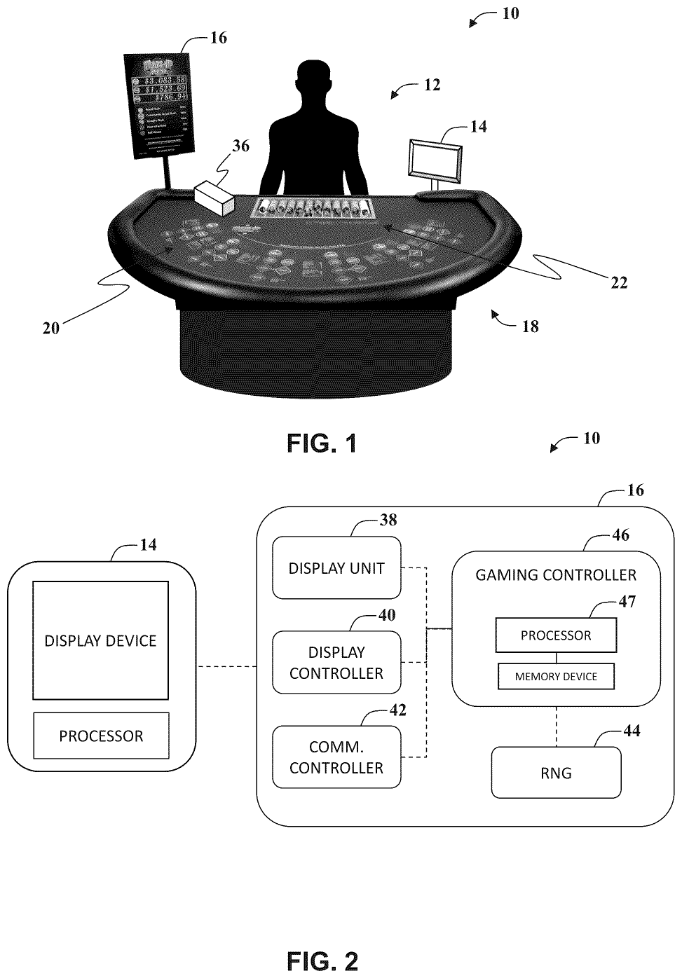

Referring to FIGS. 1-4, in the illustrated embodiment, the present invention includes a table game system 10 for displaying computer-generated animated images on an electronic trend board. For example, the table game system 10 may include the Triton Casino System™ offered by Galaxy Gaming™.

In the illustrated embodiment, the table game system 10 includes a gaming table assembly 12, a dealer terminal 14, and a gaming table display assembly 16 such as, for example, an electronic trend board.

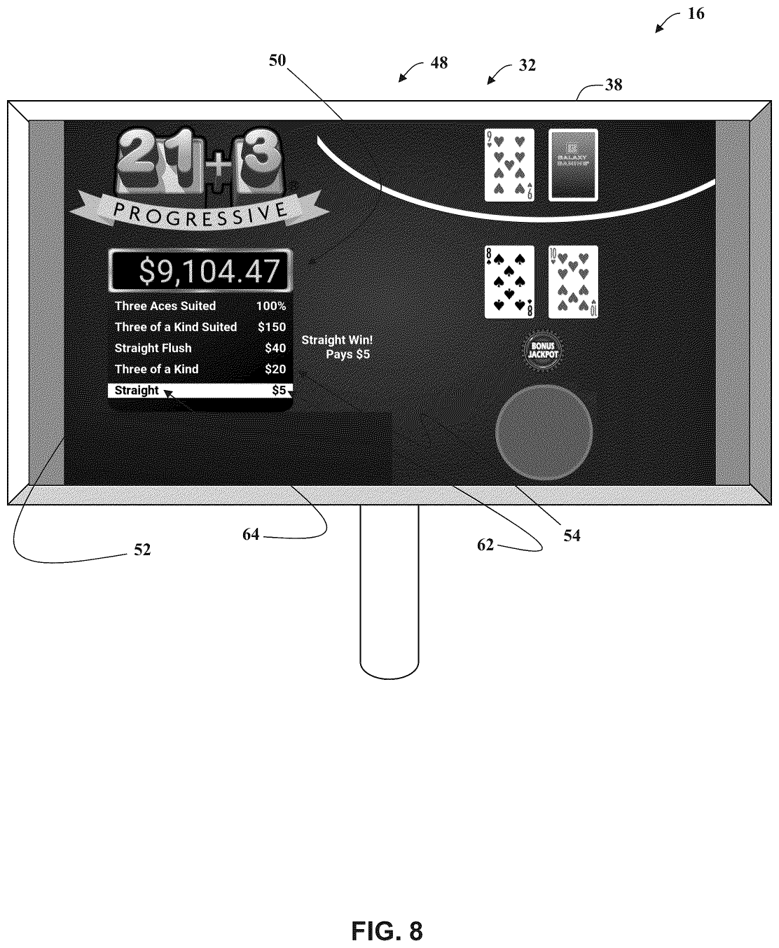

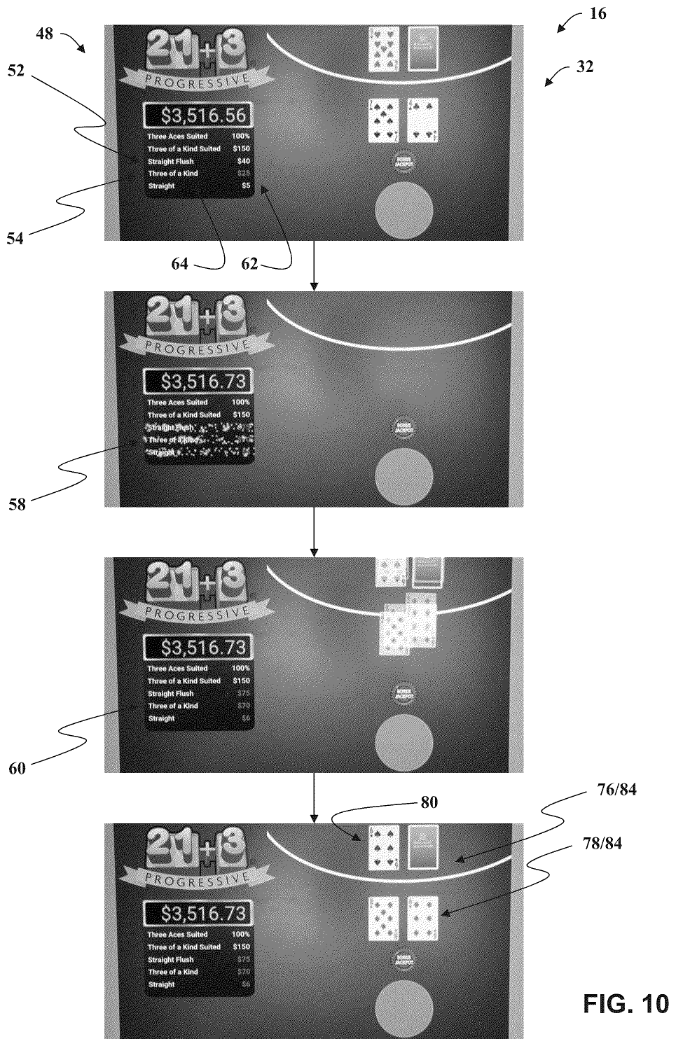

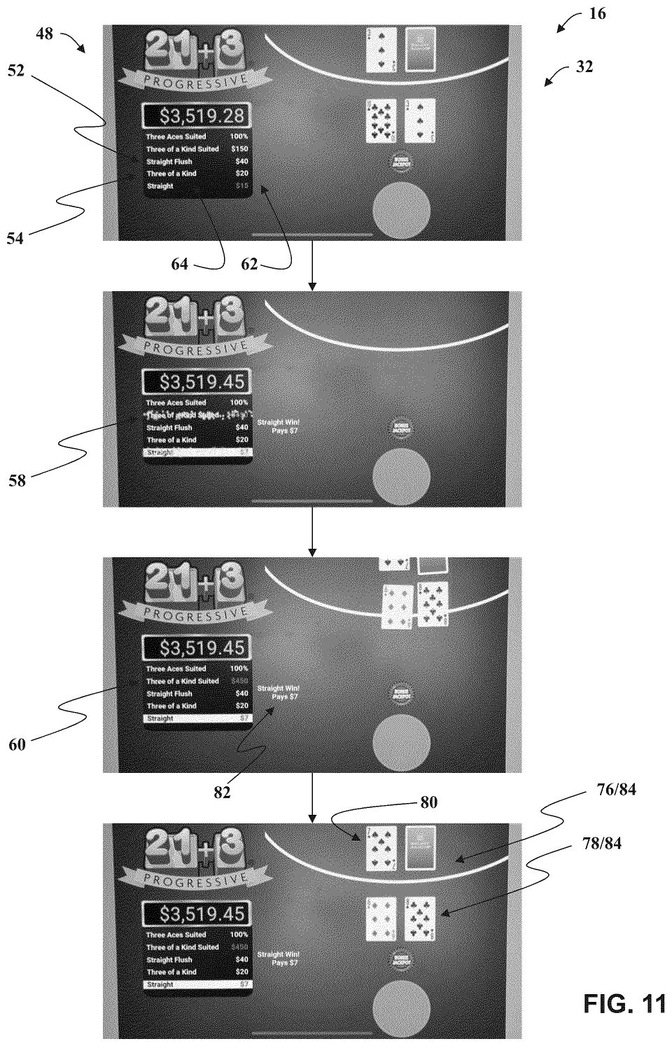

The gaming table assembly 12 includes a physical gaming table 18 including a plurality of player stations 20 and a dealer station 22. Each player station 20 includes a wager area 24 for placing a wager, and a player hand area 26 for placing a player hand of dealt playing cards. The wager area 24 includes a primary game wager area 28 to allow the player to place a wager on a primary card game such as, for example Blackjack, Baccarat, Pai Gao, and the like, and a side-bet wager area 30 to allow a player to place a wager on a bonus progressive card game 32 (shown in FIGS. 8-11). The gaming table assembly 12 may also include a plurality of bet sensors 34 positioned at the primary game wager area 28 and/or the side-bet wager area 30.

For example, a bet sensor 34 may be mounted to the physical gaming table 18 and associated with a corresponding wager area 28, 30. The bet sensors 34 are configured to detect the presence of a physical betting chip being placed within the corresponding wager area and transmit a signal to the dealer station 22 to prompt the dealer station 22 to display a notification message indicating a wager has been placed at the corresponding player station 20. The bet sensor 34 may include, but is not limited to, a proximity sensor, a pressure sensor, a barcode reader, a magnetic card reader, a RFID card reader, and/or camera or video based or some other technology. The gaming table assembly 12 may also include an electronic card shuffler 36 for storing a deck of physical playing cards and automatically shuffling the deck of cards to be dealt by the dealer. The electronic card shuffler 36 may also include a card reader device configured to acquire information from a physical playing card being dealt from the electronic card shuffler 36 and provide information indicating a playing card being dealt by the dealer. The card reader device is adapted to identify each physical playing card being dealt by the human dealer and transmit the information indicative of the identified playing card to the dealer station 22. The card reader device may include, but is not limited to, a barcode reader, a magnetic card reader, a RFID card reader, optical sensor, and/or camera or video based or some other technology. In some embodiments, the card reader device may be a separate device from the electronic card shuffler 36.

The dealer terminal 14 includes a touchscreen display device and a processor coupled to the display device and programmed to display computer-generated images on the display device. The processor of the dealer terminal 14 is configured to display images to the human dealer during a game to provide instructions on dealing physical playing cards. For example, the dealer terminal 14 may display images indicating wagers being played by corresponding players to allow the dealer to resolve wagers placed on primary games and/or progressive side-bets. The dealer display device 24 may be coupled to the gaming table 20 and positioned to enable the dealer to view the dealer terminal 14 to facilitate conducting the game in response to physical betting chips sensed by the bet sensors 34.

The gaming table display assembly 16 includes a display unit 38 for displaying computer-generated images, a display controller 40 for operating the display unit 38, a communications controller 42 coupled to the dealer terminal 14, a random number generator 44, and a gaming controller 46 for operating the display unit 38, display controller 40, and communications controller 42. The gaming table display assembly 16 may include, for example, the Lunar Table Display™ and/or the TableVision™ gaming table display offered by Galaxy Gaming™

The display unit 38 may include a flat panel display, such as a liquid crystal display (LCD), a light-emitting diode display (LED), active-matrix organic light-emitting diode (AMOLED), a plasma display, and/or any suitable visual output device capable of displaying graphical data, video images, and/or text to a user. The display controller 40 operates the display unit 38 to display computer-generated images based on instructions received from the gaming controller 46.

The communications controller 42 transmits data and instructions between the dealer terminal 14 and the gaming controller 46 to allow the gaming controller 46 to operate the dealer terminal 14 to display information and dealer instructions related to game play to the dealer. In addition, the gaming controller 46 may receive dealer selections via the dealer terminal touchscreen for use in displaying the bonus progressive card game 32 on the display unit 38. The gaming controller 46 may also be operably coupled to the electronic card shuffler 36 and configured to receive signals from the electronic card shuffler 36 indicating card values associated with physical playing cards being dealt from the electronic card shuffler 36.

The gaming controller 46 includes a memory device for storing computer-readable instructions for conducting a bonus progressive card game and a processor 47 programmed to execute the computer-readable instructions to operate the display unit 38 to display a sequence of animated computer-generated images associated with the bonus progressive card game 32 to the players.

The random number generator 44 generates and outputs random numbers to the gaming controller 46 for use in playing the bonus progressive card game 32. The random number generator 44 may generate random numbers based on predetermined algorithm of computational random generation method and/or a pseudorandom generator.

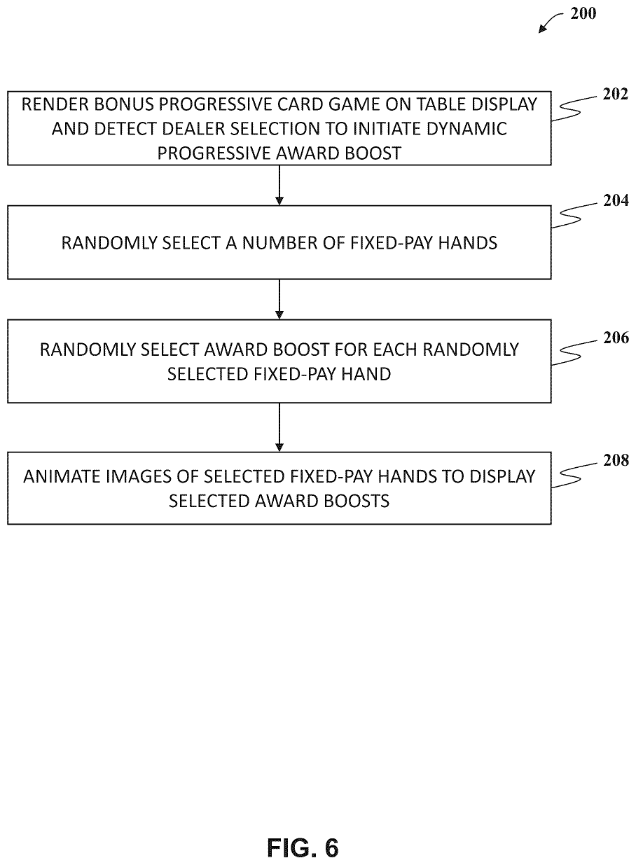

FIG. 6 is a flow chart of a method 200 illustrating the algorithms performed by the processor of the gaming controller 46 to render an animated sequence of computer-generated images of the bonus progressive card game 32 on the display unit 38 of the gaming table display assembly 16. The methods include a plurality of steps. Each method step may be performed independently of, or in combination with, other method steps. Portions of the methods may be performed by any one of, or any combination of, the components of the system. FIGS. 8-11 are exemplary illustrations of games screens and animated computer-generated images rendered on the gaming table display assembly 16 when implementing the algorithms illustrated in method 200. For example, the processor of the gaming controller 46 may be programmed to execute computer-executable instructions including algorithms for providing the Dynamic Progressive™ feature offered by Galaxy Gaming™.

In the illustrated embodiment, the gaming controller 46 is programmed to execute an algorithm to perform a table games-based progressive paytables where every round, a number (random or fixed) of fixed/rack (non-percentage) pays are changed to a new amount. An RNG chooses the number of hands that will be increased along with the new value for each chosen hand.

For example, in method step 202, the processor 47 of the gaming controller 46 renders a game screen 48 (shown in FIGS. 8-11) on the display unit 38 of the gaming table display assembly 16 displaying the bonus progressive card game 32. The bonus progressive card game 32 is displayed including an animated progressive jackpot award image 50 and an animated progressive award paytable image 52. The animated progressive jackpot award image 50 includes an image of a progressive jackpot award that increases with wager placed on a primary card game. The animated progressive award paytable image 52 includes a plurality of fixed-pay hand bonus award images 54. Each fixed-pay hand bonus award image 54 includes a modifiable bonus award image 62 and a corresponding card hand image 64. For example, as shown in FIGS. 8-11, the processor 47 renders the game screen 48 on the display unit 38 including an animated progressive jackpot award image 50 and an animated progressive award paytable image 52. The processor 47 renders the animated progressive award paytable image 52 including a plurality of fixed-pay hand bonus award images 54. Each fixed-pay hand bonus award image 54 including a card hand image 64 indicating a corresponding playing card hand and a modifiable bonus award image 62.

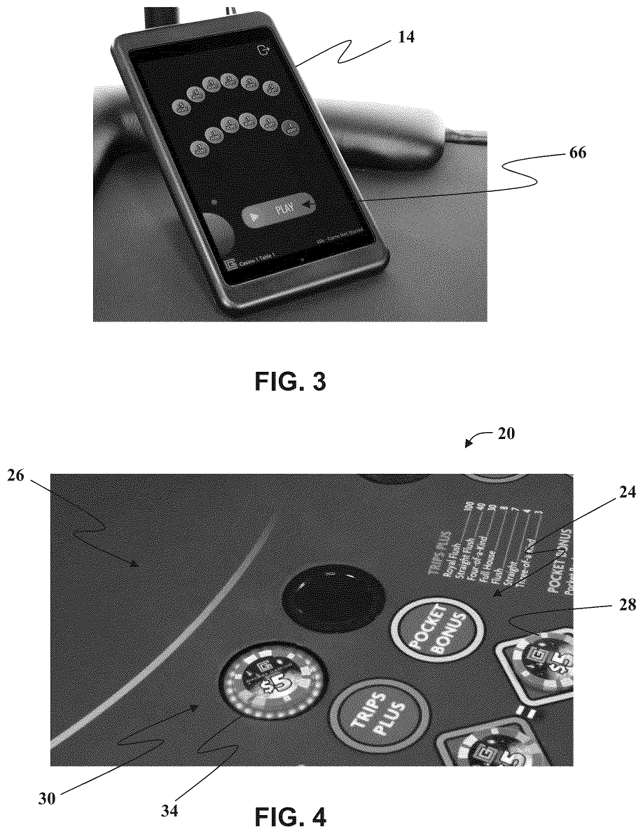

In some embodiments, the gaming controller 46 detects a placement of a side-bet wager by a player via the bet sensor 34 and displays a notification on the dealer terminal 14 to notify the dealer to initiate the bonus progressive card game 32. The gaming controller 46 then initiates the bonus progressive card game 32 upon detecting the dealer's selection of a start button via the touchscreen dealer terminal 14. For example, the processor 47 may be programmed to display a notification message on the dealer terminal 14 including a start button 66 (shown in FIG. 3) prompting the dealer to initiate the bonus progressive card game 32, and initiate an instance of the bonus progressive card game 32 upon detecting a dealer's selection of the start button 66. The processor 47 may also be programmed to display the notification message on the dealer terminal 14 upon receiving a signal from a bet sensor 34 indicating the physical betting chip being placed within a corresponding wager area 28, 30 to prompt the dealer to initiate the bonus progressive card game 32. The processor 47 may also receive a signal from the electronic card shuffler 36 and/or card reader device indicating card values associated with physical playing cards dealt to a player and a dealer and initiate an instance of the bonus progressive card game 32 upon detecting a physical playing card being dealt from the electronic card shuffler 36.

In method step 204, the gaming controller 46 initiates the bonus progressive card game 32 by retrieving a random number from the random number generator 44 and randomly selecting one or more of the fixed-pay hand bonus award images 54 displayed on the animated progressive award paytable image 52.

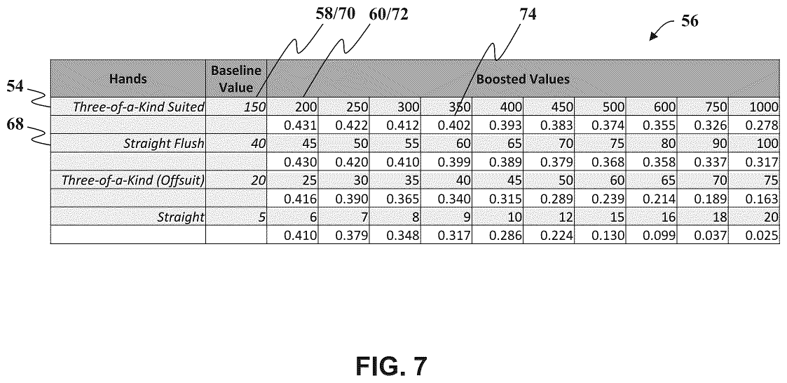

In method step 206, the gaming controller 46 retrieves another random number from the random number generator 44 and randomly selects an award boost for each randomly selected fixed-pay hand bonus award image 54. For example, in some embodiments, the gaming controller 46 may access an award boost data file 56 (shown in FIG. 7) that includes information associated with each fixed-pay hand bonus award image 54 including baseline award values 58 and a plurality of boosted award values 60 associated with each fixed-pay hand bonus award image 54. Each boosted award value 60 is associated with a corresponding selection probability.

For example, in some embodiments, the award boost data file 56 includes fixed-pay hand bonus award indicators 68 associated with each fixed-pay hand bonus award image 54 being displayed with the animated progressive award paytable image 52. Each fixed-pay hand bonus award indicator 68 is associated with a baseline award value indicator 70, a plurality of boosted award value indicators 72, and selection probabilities 74 associated with each boosted award value indicator 72. Upon receiving the random number from the random number generator 44, the gaming controller 46 accesses the award boost data file 56 and randomly selects a boosted award value 60 for each randomly selected fixed-pay hand bonus award image 54 using the retrieved random number and the associated selection probabilities.

In method step 208, upon selecting the boosted award values 60 for each randomly selected fixed-pay hand bonus award image 54, the gaming controller 46 then animates the modifiable bonus award image associated with each randomly selected fixed-pay hand bonus award image 54 to display the selected boosted award values 60, as shown in the animated sequence illustrated in FIGS. 8-11. The gaming controller 46 may then display a message on the dealer terminal 14 to notify the dealer that the bonus progressive card game 32 has been initiated and prompt the dealer to initiate a deal of the primary card game. In some embodiments, the gaming controller 46 may receive signals from the electronic card shuffler 36 indicating the cards being dealt by the dealer to the players and display the card hands on the display unit 38 of the gaming table display assembly 16. The gaming controller 46 may then evaluate the card hands to determine a result of the bonus progressive card game 32 and display the outcome of the bonus progressive card game 32 on the gaming table display assembly 16.

In some embodiments, the processor 47 is programmed to initiate an instance of a bonus progressive card game 32 by randomly selecting a fixed-pay hand bonus award image 54 being displayed on the animated progressive award paytable image 52 and randomly selecting an award boost value 60 for the randomly selected fixed-pay hand bonus award image 54. For example, the processor 47 may access the award boost data file 56 (shown in FIG. 7) that includes fixed-pay hand bonus award indicators 68 associated with each fixed-pay hand bonus award image 54 being displayed with the animated progressive award paytable image 52, with each fixed-pay hand bonus award indicator 68 being associated with a baseline award value indicator 70, a plurality of boosted award value indicators 72, and selection probabilities 74 associated with each boosted award value indicator 72. The processor 47 then identifies a fixed-pay hand bonus award indicator 68 matching the randomly selected a fixed-pay hand bonus award image 54, retrieves a random number from a random number generator 44, and randomly selects the boosted award value 60 from the plurality of boosted award value indicators 72 associated with the identified fixed-pay hand bonus award indicator 68 using the retrieved random number.

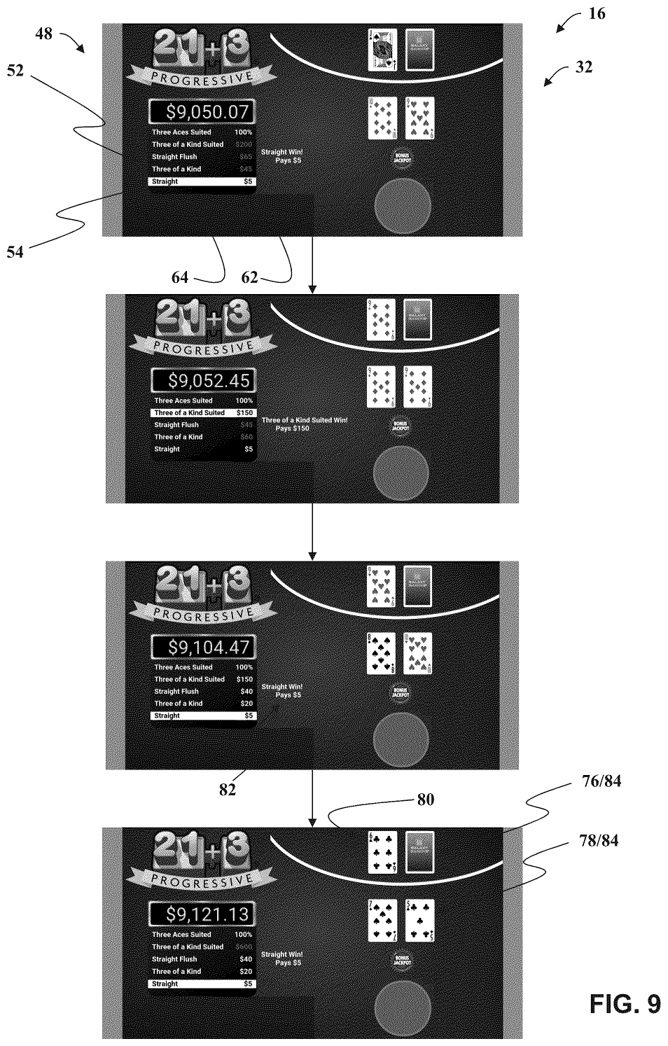

As shown in FIGS. 9-11, the processor 47 then animates the modifiable bonus award image 62 associated with the randomly selected fixed-pay hand bonus award image 54 to transform from an initial baseline award value 58 to the selected boosted award value 60. The processor 47 also determines a player bonus hand 76 based on the card values associated with two playing cards 78 dealt to the player and one playing card 80 dealt to the dealer and animates an award image 82 onto the game screen upon determining the player bonus hand 76 matches one of the fixed-pay hand bonus award images 54.

In some embodiments, the processor 47 may be programmed to associate each fixed-pay hand bonus award image 54 with a corresponding three card poker hand and animate each corresponding card hand image 64 to indicate each corresponding three card poker hand. The processor 47 may also animate the award image 82 onto the game screen 48 upon determining the player bonus hand 76 matches one of the corresponding three card poker hands. For example, as shown in FIGS. 9-11, the processor 47 may animate card images 84 onto the game screen 48 simulating playing cards associated with the physical playing cards dealt to the player and the dealer including a simulated player hand 78 and a simulated dealer hand 76.

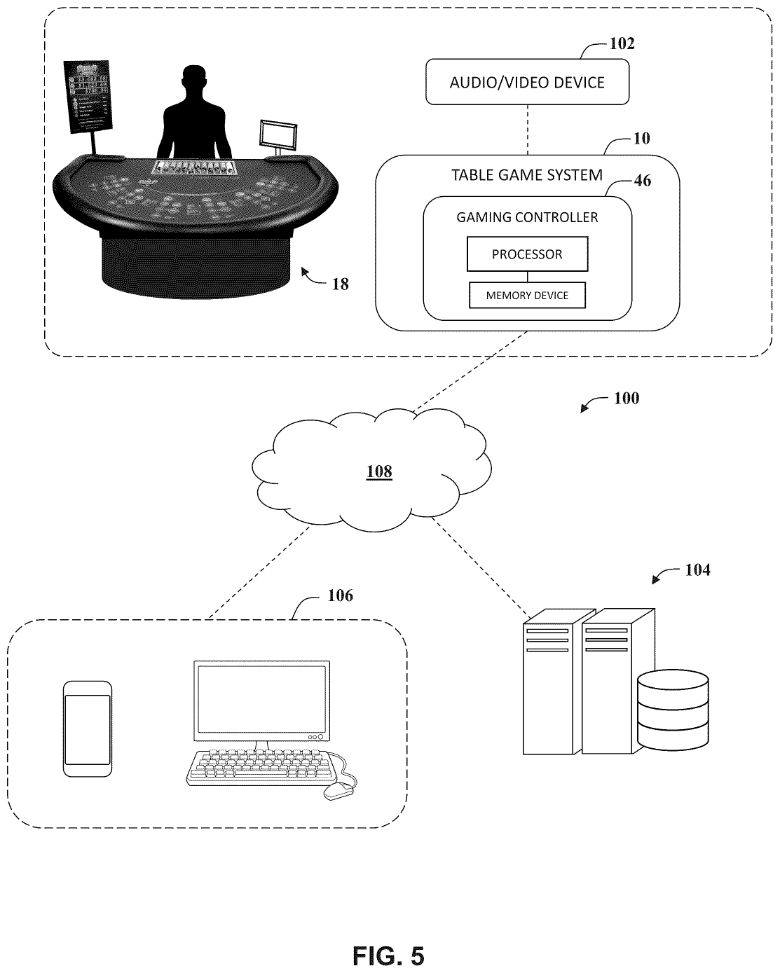

Referring to FIG. 5, in some embodiments, the present invention includes a networked computer system 100 for use in displaying computer-generated animated images of live remote dealer games. The networked computer system 100 includes the table game system 10, an audio/video device 102, and a gaming server 104 coupled to the table game system 10, the audio/video device 102, and one or more user computing devices 106 via a communications network 108 for rendering animated images of live remote dealer games on the user computing devices 106.

The user computing devices 106 may include, but are not limited to, a desktop computer, a laptop or notebook computer, a tablet computer, smartphone/tablet computer hybrid, a personal data assistant, a handheld mobile device including a cellular telephone, and the like. In addition, the user computing devices 106 may include a touchscreen that operates as the display device and the user input device. In the illustrated embodiment, a user computing device 106 includes a web-browser program that is stored in the memory device. When executed by the processor of the user computing device, the web-browser program enables the user computing device to receive software code from the system 100 including, but not limited to, HTML, JavaScript, and/or any suitable programming code that enables the user computing device to generate and display a website and/or webpages on the display device of the user computing device.

In one embodiment, the user computing device 106 may include a mobile computing device such as, for example, a tablet computer, a smartphone/tablet computer hybrid, a smartphone such as an iPhone™, Samsung Galaxy™, Google Pixel™ and the like. The mobile computing device includes a processor coupled to a memory device for storing various programs and data for use in operating the mobile computing device. The mobile computing device may also include a touchscreen display unit, one or more video image cameras, one or more speakers, a microphone, at least one input button, and one or more sensors including, but not limited to, a touch ID fingerprint sensor coupled to an input button, a barometer, a three-axis gyro, an accelerometer, proximity sensor, and an ambient light sensor. In addition, the mobile computing device may also include a Wi-Fi antenna, a cellular network antenna, a Bluetooth™ communications device, assisted GPS and GLONASS, a digital compass, and an iBeacon™ microlocation device. The mobile computing device may be programmed to store and execute mobile computer program applications that display graphical user interfaces on the touchscreen display unit that allows the user to access the system 100 to retrieve and store information within the system 10 as well as interact with and operate the system 100.

The communications network 108 may be any suitable connection, including the Internet, file transfer protocol (FTP), an Intranet, LAN, a virtual private network (VPN), cellular networks, etc . . . , and may utilize any suitable or combination of technologies including, but not limited to, wired and wireless connections, always on connections, connections made periodically, and connections made as needed.

The audio/video device 102 is configured to record audio and video data of the activities being performed by the human dealer and transmit the captured audio and video images to the gaming controller 46 and/or the gaming server 104. For example, the audio/video device 102 may include a video imaging device such as, for example, a video camera that is configured to capture and transmit images of the live human dealer and the gaming table, and a microphone to capture audio of the live human dealer during the game.

The gaming server 104 includes a processor that is programmed to received information from the gaming controller 46 and generate and display the game on the user computing devices 106. For example, the gaming server 104 is programmed to received data associated with the game play from the gaming controller 46, render and display computer-animated images of playing cards on the user computing devices, receive player's selections via the user computing devices 106, provide instructions to the gaming controller 46 based on the player's selections, and animate images of game play on the user computing devices 106 based on the dealer's recorded activities and the player's selections. In the illustrated embodiment, the gaming server 104 is programmed to execute the steps of the algorithm illustrated in method 200 to display the bonus progressive card game 32 on the user computing devices 106 based on the dealer's recorded activities and the player's selections

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A table game system, comprising:
a physical gaming table;
a card reader device configured to acquire information from a physical playing card being dealt onto the physical gaming table; and
a gaming table display assembly coupled to the physical gaming table, the gaming table display assembly including:
a display unit for displaying computer-generated images; and
a gaming controller operably coupled to the display unit and the card reader device, the gaming controller including a processor programmed to execute an algorithm to render an animated sequence of computer-generated images on the display unit including the steps of:
rendering a game screen on the display unit including an animated progressive jackpot award image and an animated progressive award paytable image;
rendering the animated progressive award paytable image including a plurality of fixed-pay hand bonus award images, each fixed-pay hand bonus award image including a card hand image indicating a corresponding playing card hand and a modifiable bonus award image;
receiving a signal from the card reader device indicating card values associated with physical playing cards dealt to a player and a dealer; and
initiating an instance of a bonus progressive card game by:
randomly selecting a fixed-pay hand bonus award image being displayed on the animated progressive award paytable image;
randomly selecting an award boost value for the randomly selected fixed-pay hand bonus award image;
animating the modifiable bonus award image associated with the randomly selected fixed-pay hand bonus award image to transform from an initial baseline award value to the selected boosted award value;
determining a player bonus hand based on the card values associated with two playing cards dealt to the player and one playing card dealt to the dealer; and
animating an award image onto the game screen upon determining the player bonus hand matches one of the fixed-pay hand bonus award images.

2. The table game system of claim 1, wherein the processor is programmed to execute the algorithm including the steps of:
associating each fixed-pay hand bonus award image with a corresponding three card poker hand;
animating each corresponding card hand image to indicate each corresponding three card poker hand; and
animating the award image onto the game screen upon determining the player bonus hand matches one of the corresponding three card poker hands.

3. The table game system of claim 1, wherein the processor is programmed to execute the algorithm including the steps of:
animating card images onto the game screen simulating playing cards associated with the physical playing cards dealt to the player and the dealer including a simulated player hand and a simulated dealer hand.

4. The table game system of claim 1, wherein the processor is programmed to execute the algorithm including the steps of:
initiating the instance of the bonus progressive card game upon detecting a physical playing card being dealt from the card reader device.

5. The table game system of claim 1, further comprising:
a dealer terminal including a touchscreen display device;
wherein the processor is programmed to execute the algorithm including the steps of:
displaying a notification message on the dealer terminal including a start button prompting the dealer to initiate the bonus progressive card game; and
initiating the instance of the bonus progressive card game upon detecting a dealer's selection of the start button.

6. The table game system of claim 5, further comprising:
a bet sensor mounted to the physical gaming table and associated with a wager area, the bet sensor configured to detect a presence of a physical betting chip being placed within the wager area; and
wherein the processor is programmed to execute the algorithm including the steps of:
display the notification message on the dealer terminal upon receiving a signal from the bet sensor indicating the physical betting chip being placed within the wager area to prompt the dealer to initiate the bonus progressive card game.

7. The table game system of claim 1, wherein the processor is programmed to execute the algorithm including the steps of:
accessing an award boost data file including fixed-pay hand bonus award indicators associated with each fixed-pay hand bonus award image being displayed with the animated progressive award paytable image, each fixed-pay hand bonus award indicator associated with a baseline award value indicator, a plurality of boosted award value indicators, and selection probabilities associated with each boosted award value indicator;
identifying a fixed-pay hand bonus award indicator matching the randomly selected a fixed-pay hand bonus award image;
retrieving a random number from a random number generator; and
randomly selecting the boosted award value from the plurality of boosted award value indicators associated with the identified fixed-pay hand bonus award indicator using the retrieved random number.

8. A gaming table display assembly associated with a physical gaming table, comprising:
a display unit for displaying computer-generated images; and
a gaming controller operably coupled to the display unit, the gaming controller including a processor programmed to execute an algorithm to render an animated sequence of computer-generated images on the display unit including the steps of:
rendering a game screen on the display unit including an animated progressive jackpot award image and an animated progressive award paytable image;
rendering the animated progressive award paytable image including a plurality of fixed-pay hand bonus award images, each fixed-pay hand bonus award image including a card hand image indicating a corresponding playing card hand and a modifiable bonus award image;
receiving a signal from a card reader device indicating card values associated with physical playing cards dealt to a player and a dealer; and
initiating an instance of a bonus progressive card game by:
randomly selecting a fixed-pay hand bonus award image being displayed on the animated progressive award paytable image;
randomly selecting an award boost value for the randomly selected fixed-pay hand bonus award image;
animating the modifiable bonus award image associated with the randomly selected fixed-pay hand bonus award image to transform from an initial baseline award value to the selected boosted award value;
determining a player bonus hand based on the card values associated with two playing cards dealt to the player and one playing card dealt to the dealer; and
animating an award image onto the game screen upon determining the player bonus hand matches one of the fixed-pay hand bonus award images.

9. The gaming table display assembly of claim 8, wherein the processor is programmed to execute the algorithm including the steps of:
associating each fixed-pay hand bonus award image with a corresponding three card poker hand;
animating each corresponding card hand image to indicate each corresponding three card poker hand; and
animating the award image onto the game screen upon determining the player bonus hand matches one of the corresponding three card poker hands.

10. The gaming table display assembly of claim 8, wherein the processor is programmed to execute the algorithm including the steps of:
animating card images onto the game screen simulating playing cards associated with the physical playing cards dealt to the player and the dealer including a simulated player hand and a simulated dealer hand.

11. The gaming table display assembly of claim 8, wherein the processor is programmed to execute the algorithm including the steps of:
initiating the instance of the bonus progressive card game upon detecting a physical playing card being dealt from the card reader device.

12. The gaming table display assembly of claim 8, wherein the processor is programmed to execute the algorithm including the steps of:
displaying a notification message on a dealer terminal touchscreen including a start button prompting the dealer to initiate the bonus progressive card game; and
initiating the instance of the bonus progressive card game upon detecting a dealer's selection of the start button via the dealer terminal touchscreen.

13. The gaming table display assembly of claim 12, wherein the processor is programmed to execute the algorithm including the steps of:
displaying the notification message on the dealer terminal touchscreen upon receiving a signal from a bet sensor indicating a physical betting chip being placed within a wager area of the physical gaming table to prompt the dealer to initiate the bonus progressive card game.

14. The gaming table display assembly of claim 8, wherein the processor is programmed to execute the algorithm including the steps of:
accessing an award boost data file including fixed-pay hand bonus award indicators associated with each fixed-pay hand bonus award image being displayed with the animated progressive award paytable image, each fixed-pay hand bonus award indicator associated with a baseline award value indicator, a plurality of boosted award value indicators, and selection probabilities associated with each boosted award value indicator;
identifying a fixed-pay hand bonus award indicator matching the randomly selected a fixed-pay hand bonus award image;
retrieving a random number from a random number generator; and
randomly selecting the boosted award value from the plurality of boosted award value indicators associated with the identified fixed-pay hand bonus award indicator using the retrieved random number.

15. A method of operating a gaming table display assembly associated with a physical gaming table, the gaming table display assembly including a display unit for displaying computer-generated images and a gaming controller including a processor operably coupled to the display unit, the method including the processor performing an algorithm to render an animated sequence of computer-generated images on the display unit including the steps of:
rendering a game screen on the display unit including an animated progressive jackpot award image and an animated progressive award paytable image;
rendering the animated progressive award paytable image including a plurality of fixed-pay hand bonus award images, each fixed-pay hand bonus award image including a card hand image indicating a corresponding playing card hand and a modifiable bonus award image;
receiving a signal from a card reader device indicating card values associated with physical playing cards dealt to a player and a dealer; and
initiating an instance of a bonus progressive card game by:
randomly selecting a fixed-pay hand bonus award image being displayed on the animated progressive award paytable image;
randomly selecting an award boost value for the randomly selected fixed-pay hand bonus award image;
animating the modifiable bonus award image associated with the randomly selected fixed-pay hand bonus award image to transform from an initial baseline award value to the selected boosted award value;
determining a player bonus hand based on the card values associated with two playing cards dealt to the player and one playing card dealt to the dealer; and
animating an award image onto the game screen upon determining the player bonus hand matches one of the fixed-pay hand bonus award images.

16. The method of claim 15, including the processor performing the algorithm including the steps of:
associating each fixed-pay hand bonus award image with a corresponding three card poker hand;
animating each corresponding card hand image to indicate each corresponding three card poker hand; and
animating the award image onto the game screen upon determining the player bonus hand matches one of the corresponding three card poker hands.

17. The method of claim 15, including the processor performing the algorithm including the steps of:
animating card images onto the game screen simulating playing cards associated with the physical playing cards dealt to the player and the dealer including a simulated player hand and a simulated dealer hand.

18. The method of claim 15, including the processor performing the algorithm including the steps of:
initiating the instance of the bonus progressive card game upon detecting a physical playing card being dealt from the card reader device.

19. The method of claim 15, including the processor performing the algorithm including the steps of:
displaying a notification message on a dealer terminal touchscreen including a start button prompting the dealer to initiate the bonus progressive card game; and
initiating the instance of the bonus progressive card game upon detecting a dealer's selection of the start button via the dealer terminal touchscreen.

20. The method of claim 19, including the processor performing the algorithm including the steps of:
displaying the notification message on the dealer terminal touchscreen upon receiving a signal from a bet sensor indicating a physical betting chip being placed within a wager area of the physical gaming table to prompt the dealer to initiate the bonus progressive card game.
